(19) United States
(12) Patent Application Publication
(10) Pub. No.: US 2003/0231579 A1
(43) Pub. Date: Dec. 18, 2003

(54) Method for enhancing music signal fidelity derived from a compact disk

(76) Inventors: Ky Tan, Costa Mesa, CA (US); Lee Tan, Costa Mesa, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/421,402

(22) Filed: Apr. 22, 2003

Related U.S. Application Data
(63) Continuation-in-part of application No. 09/755,464, filed on Jan. 5, 2001, now abandoned.

(51) Int. Cl. G11B 23/20

(52) U.S. Cl. 369/292

(57) ABSTRACT

A method for enhancing music signal fidelity derived from a compact disk storage media comprises exposing the encoded surface of the compact disk music storage media to a series of color fields in sequence immediately prior to playing the compact disk. Preferably the color fields correspond to light wavelength bands: 580-610 nm; 610-660 nm; 540-580 nm; 460-660 nm; and 450-460 nm, respectively.

### RELATED APPLICATIONS

This is a continuation-in-part application of a prior filed and currently pending application having Ser. No. 09/755,464 and file date of Jan. 5, 2001.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to the fidelity of music signals originating from compact disk storage media and more particularly to a method of temporarily enhancing such signals for improved fidelity listening.

2. Description of Related Art

“Compact disk,” or CD, is the name given to a specific digital medium currently in wide commercial use. This medium provides portable storage of a relatively large amount of information; typically approximately 700 million digital bits per disk. A laser optical system is used to read such a disk because a laser beam is able to be focused onto a relatively small physical spot, that is, in the range of a micrometer or less in diameter, and because it transmits light variations nearly instantaneously, it is ideally suited to read variations in such physical spots across the surface of the CD, at a high rate of speed; up to tens of thousands of bits per second. Such a combination is ideal for permanently storing, reading and converting to useful electrical signals, both sound and picture information with high fidelity.

However, in the field of professional music storage and reproduction, the CD and its reproductive electronic system (CD systems) does not seem to provide the highest level of fidelity demanded by the audiophile. Even the finest and most expensive CD systems are not preferred over the much older and well known mechanical turntable systems, for instance, which use vinyl pressed disks with recorded music encoded in grooves within which a mechanical stylus moves.

Relevant prior art includes the following references:

Bernardini, U.S. Pat. No. 4,083,073 describes a device for neutralizing electrostatic charge and removing dust and particles attached by the charges on a gramaphone record or disc, the device comprising a body; a handle on the body for hand operation of the device adjacent to a surface of the disc to be treated; a cap head and a pushbutton on the body; at least one ionic flux—and electric field—generating electrode within the cap head; a piezoelectric generator in the body activated by the pushbutton; and brush means on at least a portion of an edge of the cap to remove dust from said surface immediately after said surface has passed in front of the cap and has been subjected to the action of ionic flux and electric field from the electrode.

English, U.S. Pat. No. 4,139,201 describes the methods and apparatus for removing dust from, or preventing dust from being attracted to, record discs. This is achieved by giving a negative charge to the dust particles in the atmosphere in which the record disc is located. Record discs are normally negatively-charged and, accordingly, negatively-charged dust particles are repelled by the record disc. The negative charge on the dust particles is produced by injecting negative ions into the atmosphere. Such negative ions may be produced by any suitable high-voltage generator with its positive pole earthed and its negative pole connected to one or more discharge electrodes. Preferably a brush is provided to disturb the dust in the grooves and a pad is provided to pick up the dust. Thus the record cleaner may consist of a pivotally-mounted arm carrying a brush and a pad, said arm being mounted on apparatus for producing negative air ions.

Hahne, et al., U.S. Pat. No. 4,835,808 describes A probe is employed for removing dust from moving webs, paper webs for example. It has at least one electrostatic high-voltage electrode, at least one blower for gas, preferably air, oriented against the direction that the web travels in, and a vacuum channel for suctioning up the dust-laden gas. The pointed or blade-shaped subsidiary electrodes in the high-voltage electrode lie in a plane that does not parallel the web. The direction that the row of round and/or slotted nozzles in the blower blow along lies in another plane downstream of the high-voltage electrode. The two planes intersect at a line that lies in the plane of the web and extends across it. The round and/or slotted openings into the vacuum channel are on the other hand positioned upstream of the high-voltage electrode in the web-travel direction.

Getreuer et al., U.S. Pat. No. 5,136,558 describes an optical disc player/recorder incorporating a laser, and an electromagnetically driven objective lens. The objective lens is mounted to a lensholder which is movable with respect to a base. A single pair of permanent magnets are mounted to the lensholder, and two pair of electromagnetic coils are mounted to the base. The coils and magnets are positioned such that one set of coils is collinear with the direction of magnetization of the permanent magnets and the other set of coils is perpendicular to the direction of magnetization of the magnets. Electromagnetic fields generated by the coils are used to move the objective lens in either a focus direction or a tracking direction. The magnets are mounted on the moveable objective lensholder, while the coils are attached in a heat-sink relationship to the fitted base. The objective lens rests on top of the objective lensholder which is suspended with respect to the base by a pair of flexures. A mirror is provided between the flexures to allow incoming laser light to enter from the side of the optical head, thereby reducing the total overall height of the system. A position sensor may be provided to detect the position of the lensholder, relative to the base of the two axis electromagnetic actuator.

Hayaski, U.S. Pat. No. 5,231,622 describes A floppy disk has a magnetic disk accommodated in a casing provided with a head insertion opening. When cleaning the floppy disk, air in the casing is sucked through the head insertion opening while the magnetic disk is rotated and ionized air is blown toward the disk surface through the head insertion opening. An ionizing needle ionizes the air before it hits the disc. Suction nozzles suck air away from the disc.

Kolbe et al., U.S. Pat. No. 5,602,817 describes a method and apparatus to improve the playback fidelity and quality of a compact disk player by controlling charge conditions in the zone of interaction between the playback read head and a CD. In one form of apparatus, an electrode is associated with the read head, and an ion generator coupled to the electrode provides an electrostatic field. The introduction of random noise to the field potentiates or enhances the improvement.

However, the prior art does not teach the present simplified and very effective method for accomplishing even broader fidelity improvements. Although it is not possible to say exactly why the present invention is so effective in improving the output fidelity of music sourced from the CD it is apparently a result of pre-structuring the electromagnetic color field on the surface of the CD. The result is temporary yet effective over the temporal playing time of a typical CD recording.

### SUMMARY OF THE INVENTION

The present invention teaches certain benefits in construction and use which give rise to the objectives described below.

A method for enhancing music signal fidelity derived from a compact disk storage media comprises exposing the encoded surface of the compact disk music storage media to a series of color fields in sequence immediately prior to playing the compact disk. Preferably the color fields are tan, red-brown, lime, black and blue. Exposure may be for as little as one second to each of the color fields and is accomplished in the order described above.

A primary objective of the present invention is to provide an apparatus and method of use of such apparatus that provides advantages not taught by the prior art.

Another objective is to provide such an invention capable of improving the sound fidelity of music produced from a compact disk medium.

A further objective is to provide such an invention capable of obtaining improved sound fidelity at least cost.

A still further objective is to provide such an invention capable of accomplishing improved sound fidelity without mechanical or electrical enhancements to recording or playback systems.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawing illustratse the present invention. In such drawing:

FIG. 1 is a perspective view of how the invention method is carried out.

### DETAILED DESCRIPTION OF THE INVENTION

The above-described drawing figure illustrates the invention in one of its preferred embodiments, which is further defined in detail in the following description.

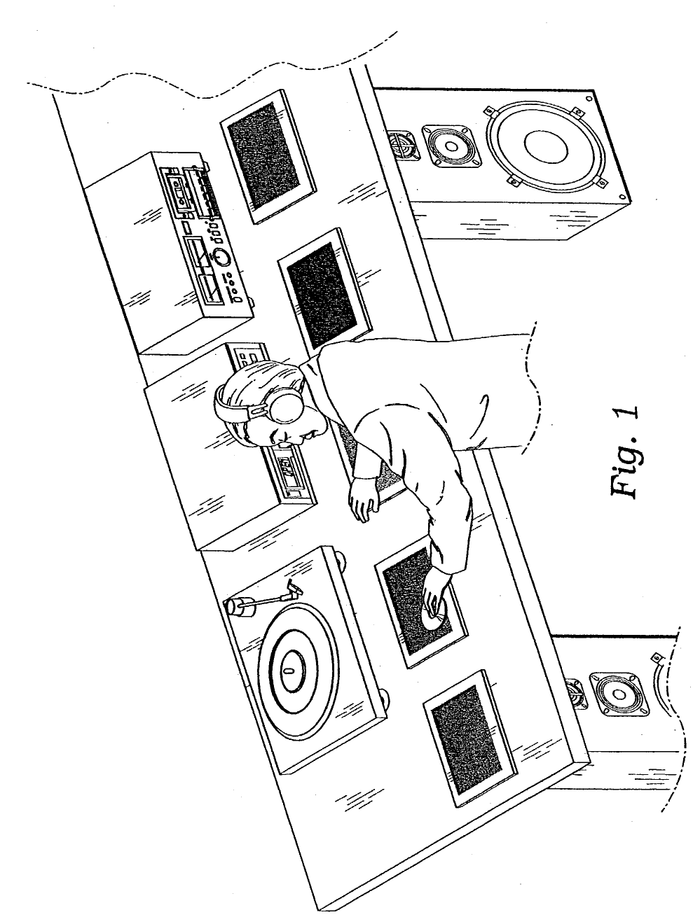

The present invention method enables the enhancing of music signal fidelity derived from a compact disk (CD) storage media. In this application, the indication “CD” shall mean all media disks that are read optically, including, but not limited to: compact disks, mini-discs, music disks, DVD disks and all other such media that is of a similar nature and use. The improvement to the reading and data transfer process in all such disks is significant whether that data results in music, spoken words, pictures or combinations of these. The method comprises exposing the encoded surface of a compact disk music storage media to a series of color fields in sequence immediately prior to playing the compact disk. Such an exposure may be accomplished, as shown in FIG. 1, by placing the CD with its encoded side facing downward over each of the color fields. The color fields may be applied in various forms such as by imprinting the color onto an area of a sheet of paper, where the colored area is significantly larger then the CD itself, or by generating the color as the output beam of an optical system light generator with the light impinging on the CD, or by playing the light onto a surface from front or behind and holding the CD adjacent to the surface, or by any other means. “Color field” in this application shall means any one of these techniques, wherein the objective is to expose the CD to the color field without extraneous light or colors entering into the field of view of the CD. In whatever manner the colors of the color fields are created, it is desired to expose the entire reading surface of the CD to each of the colors. Preferably, the color fields comprise five such fields and preferably comprise the colors: tan, red-brown, lime, black and blue. These specific colors of the color fields are more exactly defined by the following ranges of light waves inclusive: 580-610 nm producing tan; 610-660 nm producing a tan-brown; 540-580 nm producing lime; 460-660 nm producing black; and 450-460 nm producing blue, respectively. The preferred sequence of exposure is: tan, red-brown, lime, black and blue, in that order and exposure time is preferably between 1 and 5 second to each of the color fields in turn. It has been discovered that superior results are achieved when the colors, exposure sequence and duration are as defined herein. A very exhaustive research supports the present method and it has been found that small deviations in the exposure process, the colors of the color fields or the sequence of exposure can negate the improvement in fidelity possible through the present method.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A method for producing enhanced playback fidelity of music derived from a compact disk storage medium, the method comprising the steps of: (a) exposing an encoded surface of the compact disk music storage medium to a series of color fields in sequence; and (b) immediately after said exposure, playing the compact disk storage medium.

2. The method of claim 1 wherein the series of color fields comprise five fields.

3. The method of claim 2 wherein the color fields are defined by the wavelengths of light included in the light energy wavelength bands inclusive: 580-610 nm; 610-660 nm; 540-580 nm; 460-660 nm; and 450-460 nm, respectively.

4. The method of claim 3 wherein the encoded surface of the compact disk music storage medium is exposed to the five color fields in the sequence: 580-610 nm; 610-660 nm; 540-580 nm; 460-660 nm; and 450-460 nm, respectively.

5. The method of claim 4 wherein the encoded surface is exposed for between 1 and 5 second to each of the color fields.
